(19) United States
(12) Patent Application Publication
(10) Pub. No.: US 2003/0093310 A1
(43) Pub. Date: May 15, 2003

(54) Business management process

(76) Inventor: David G. Macrae, Westminster, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/196,583

(22) Filed: Jul. 16, 2002

Related U.S. Application Data
(60) Provisional application No. 60/332,188, filed on Nov. 9, 2001.

(51) Int. Cl. G06F 17/60

(52) U.S. Cl. 705/8; 705/10

(57) ABSTRACT

A method is provided for managing a business utilizing a business management process (BMP). According to one embodiment of the invention, a framework is developed for the BMP, a business and technology strategic plan is identified, strategic trends for the business are identified, one or more plans for producing goods and/or services are developed, strategic goals are defined, corporate resources are allocated to execute the business and technology strategic plan, and the business and technology strategic plan is executed.

This application claims the benefit of U.S. Provisional Application No. 60/332,188, filed Nov. 9, 2001, entitled “Business Management Process”, which is incorporated herein by reference.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### FIELD OF THE INVENTION

The invention relates generally to the field of business management. More particularly, the invention relates a method to facilitate management and growth of a successful business through the use of a customizable process consisting of standardized phases of management.

### BACKGROUND OF THE INVENTION

There are a large number of business schools that teach business subjects and books that provide information pertaining to business management. However, none of these sources provide a comprehensive method for linking the strategic and tactical levels of business management and directly relating those levels to the revenue and profits of the business.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flow diagram that illustrates the Business Management Process (BMP) lifecycle according to one embodiment of the present invention.

FIG. 2 is a block diagram that illustrates the deliverables of the Executive Planning Phase according to one embodiment of the present invention.

FIG. 3 is a flow diagram illustrating the tasks performed in the Executive Planning Phase according to one embodiment of the present invention.

FIG. 4 illustrates the deliverables of the Market Analysis Phase according to one embodiment of the present invention.

FIG. 5 is a block diagram that illustrates the deliverables of the Organizational Planning Phase according to one embodiment of the present invention.

FIG. 6 is a flow diagram illustrating the tasks performed in the Resource Allocation Phase according to one embodiment of the present invention.

FIG. 7 illustrates the tasks that are performed in the Implementation Phase according to one embodiment of the present invention.

FIG. 8 illustrates tasks that are performed in the Evaluation Phase according to one embodiment of the present invention.

FIG. 9 is a flow diagram that illustrates tasks that are performed in the Modification Phase according to one embodiment of the present invention.

### DETAILED DESCRIPTION

A method is described that seeks to facilitate managing and growing a successful business through the use of a customizable process consisting of standardized phases of management. In the following description, for the purposes of explanation, numerous specific details are set forth in order to provide a thorough understanding of the present invention. It will be apparent, however, to one skilled in the art that the present invention may be practiced without some of these specific details.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product which may include a machine-readable medium having stored thereon instructions which may be used to program a computer (or other electronic devices) to perform a process according to the present invention. The machine-readable medium may include, but is not limited to, floppy diskettes, optical disks, CD-ROMs, and magneto-optical disks, ROMs, RAMs, EPROMs, EEPROMs, magnetic or optical cards, flash memory, or other type of media/machine-readable medium suitable for storing electronic instructions.

Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

### Overview

The Business Management Process (BMP) provides a structured, process-centric approach to defining: the business direction of a company; specific, measurable goals for the company; a high-level plan to achieve those goals; and the necessary infrastructure required to support the high-level plan. It can be tailored to each business user. Use of the BMP allows everyone working for the company to truly understand the strategic direction of the business and their role in helping the business to successfully achieve the company's goals. This can lead to a reduction in wasted effort by both management and staff.

The BMP assists companies in making sound business decisions aligned with the strategic and tactical direction of the company. It allows companies to conduct resource allocation based on sound business decisions and analyzed data, rather than “turf value”, business egos, or “gut feelings” that are often wrong. The BMP may also provide horizontal and vertical alignment for multiple levels of management and implementation to ensure decision traceability and allow for ongoing process and management improvement.

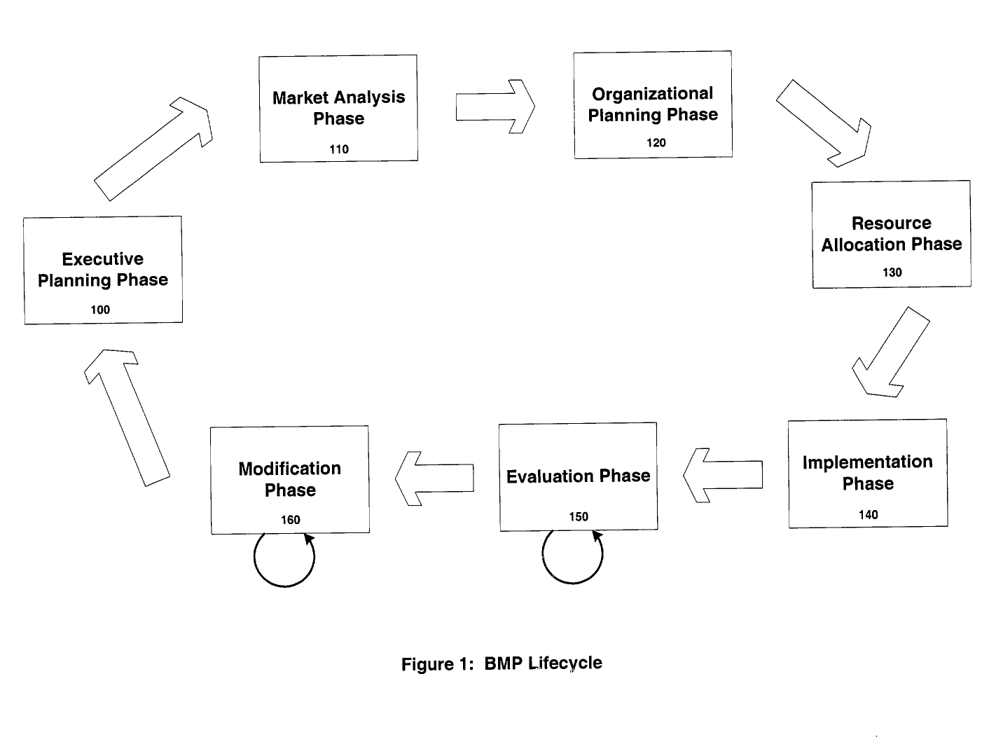

FIG. 1 illustrates an exemplary BMP lifecycle according to one embodiment of the invention. In this example, the BMP comprises seven separate, but linked, phases 100, 110, 120, 130, 140, 150, and 160. The phases of the BMP lifecycle are the Executive Planning Phase 100, the Market Analysis Phase 110, the Organizational Planning Phase 120, the Resource Allocation Phase 130, the Implementation Phase 140, the Evaluation Phase 150, and the Modification Phase 160. In one embodiment of the invention, the Evaluation Phase 150 and the Modification Phase 160 are repeated quarterly. In alternate embodiments, the Evaluation Phase 150 and/or the Modification Phase 160 may be repeated monthly, semi-annually, annually, or another time frame that meets the particular needs of a business. After the Modification Phase 160, the entire lifecycle may be repeated in whole, or in part, on an annual basis or on another time frame that meets the needs of the business.

Each phase 100-160 has deliverables that are utilized in subsequent phases. According to one embodiment of the invention, templates for those deliverables may be provided on CD-ROM or other format. These templates may be modified by the business to meet its specific needs.

It should be appreciated that the present invention does not require all seven phases discussed above in reference to FIG. 1. The BMP can be customized to fit a particular business' needs. Therefore, it is contemplated that as applied to a particular business, the BMP may not consist of all seven phases illustrated in FIG. 1. For example, the phases may be combined or divided differently.

Additionally, subsequent iterations of the lifecycle may be abbreviated from the original iteration of the lifecycle. For example, during the second iteration of the BMP, the Executive Planning Phase 100 may involve repeating the entire phase, repeating parts of the phase, reviewing the deliverables that were generated in the previous iteration, or skipping the phase.

### Executive Planning Phase

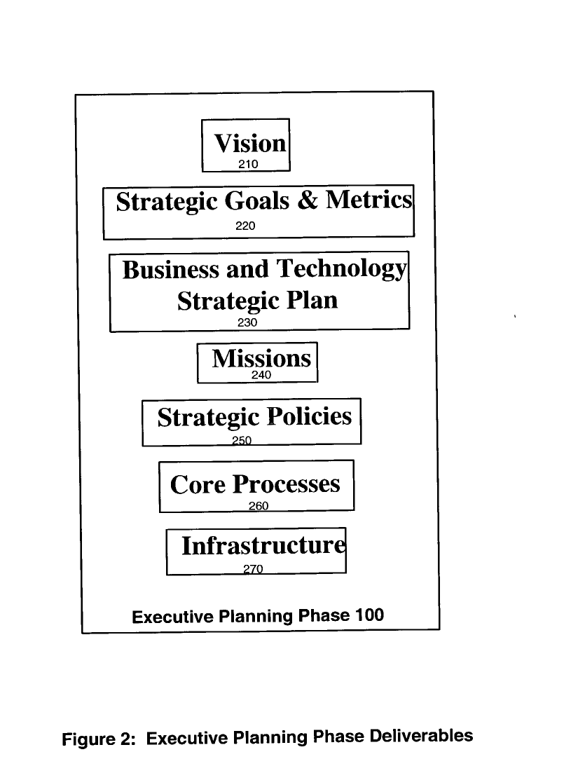

The Executive Planning Phase 100 is a phase during which executive managers define the Business Management Process (BMP) for their company and develop the framework and planning for the deployment of the BMP throughout the corporation. This phase involves the production of several deliverables, which will now be described with reference to FIG. 2. These deliverables include a Vision 210, Strategic Goals & Metrics 220, a Business and Technology Strategic Plan 230, Missions 240, Strategic Policies 250, Core Processes 260, and an Infrastructure 270.

The Vision 210 is a vivid, imaginative statement of what the business believes it should be and a view for its future direction and growth. The Strategic Goals & Metrics 220 are the strategic goals that support the Vision 210 and how the business will measure if it is meeting the goals. The Strategic Goals & Metrics 220 may be developed using a Goal, Question, Metric, Analysis (GQM/A) paradigm. The GQM/A paradigm involves developing a list of corporate goals, a list of questions for evaluation of work toward those goals, a list of metrics collected for answering the questions, and analysis models for developing and analyzing trends in the collected metrics and what those trends represent.

The Business and Technology Strategic Plan 230 is the “blueprint” for the Vision 210. It defines the Corporate strategy that forms the basis of business and technology decisions that will lead to achieving the company's strategic goals. It also serves as the linkage between strategic and operational planning. This plan is completed at a high level during the Executive Planning Phase. Additional information for the plan is provided in later phases. Further details on the Business and Technology Strategic Plan can be found in a later section of this application.

Missions 240 assign specific responsibilities to company organizations for attaining measurable goals and for implementing the Corporate strategy as defined in the Business and Technology Strategic Plan 230. Strategic Policies 250 are those polices that are critical to the business in accomplishing its mission, ensuring that strategic goals are attained, and defining the working relationships between core processes and the process owners organizations and areas of responsibilities. Departments responsible for the enforcement of each Strategic Policy 250 may also be identified.

Core Processes 260, the executive-level descriptions, and their owners are also identified in the Executive Planning Phase 100. Core Processes 260 are those processes that are critical to the business and form the basis for organizational structure, responsibility, and delivery of goods and/or services to ensure company success. A revised organizational chart based on the process-centric structure identified by the Strategic Policies 250 and the Core Processes 260 may also be produced.

Finally, Infrastructure 270 is the company framework, such as the human and budget resources, skills, training, tools, systems, education, and facilities required to successfully attain the company's Vision 210. The Infrastructure 270 may include a Current Infrastructure Identification List (CIIL) and a Future Infrastructure Identification List (FIIL). The CIIL identifies existing infrastructure elements required to successfully implement the Business and Technology Strategic Plan 230. These elements may include facilities; computer hardware for corporate, department, and individual users; computer software for corporate, department, and individual users; computer network hardware and software; office equipment; office furniture; telecommunications equipment; manufacturing equipment; vehicles; and staff skill training. The FIIL includes future infrastructure elements required to successfully implement the Business and Technology Strategic Plan 230, which may include expansions and/or updates of the elements identified in the CIIL and staff BMP training.

The Executive Planning Phase 100 is not limited to the deliverables described above. In alternate embodiments, the Executive Planning Phase 100 may include fewer deliverables or more deliverables than those described in FIG. 2.

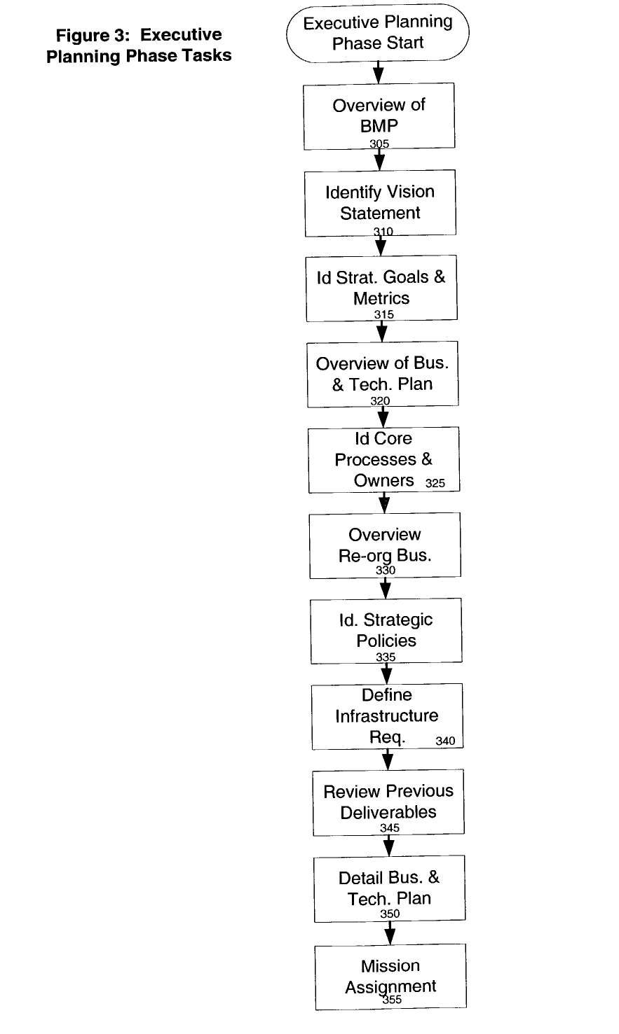

The tasks performed in the Executive Planning Phase 100 according to one embodiment of the invention will now be described with reference to FIG. 3. At the start of the Executive Planning Phase 100 an Overview of the BMP 305 is given to the executive managers. In the Identify Vision Statement 310 step, the team of executive managers identifies the company's Vision 210. In the Identify Strategic Goals & Metrics task, the team identifies the Strategic Goals & Metrics 220.

Next, in task 320 an overview of the Business and Technology Strategic Plan 230 is given to the team. Then, in task 325 the team identifies the company's Core Processes 260 and the owners of those processes. An Overview of the Reorganization of the Business 330 to a process-centric organization is then given to the team. In task 335, the team identifies the company's Strategic Policies 250.

In task 340, the team defines the infrastructure requirements required by the Vision 210, the Strategic Goals & Metrics 220, the Business and Technology Strategic Plan 230, and a process-centric organization. The team then Reviews the Previous Deliverables in task 345. A detailed Business and Technology Strategic Plan 230 is developed in task 350. Finally, in Mission Assignment 355 specific Missions 240 are assigned.

The tasks described above in reference to FIG. 3 may be performed in a different order. Additionally, alternate embodiments may include additional or fewer tasks than those described above. For example, the task of reviewing Previous Deliverables 345 may be performed periodically at the completion of one or more tasks.

### Business and Technology Strategic Plan

According to one embodiment, the Business and Technology Strategic Plan includes the following sections: Executive Summary; Business Status; Strategic Goals and Metrics; Process-Centric Business Structure; Product and/or Services Overview; Overview of Organizational Business Plans; Technology Strategy; Overview of Technology Requirements and Plans; Financial Summary; Cash Flow Overview; Issues, Assumptions and Dependencies; BMP Overview; BMP Transition Overview and Summary.

The Executive Summary section can include the following sections: Overview, Purpose, Scope, Vision Statement, Industry Overview, Core Business Overview, Business Model Overview, Business Opportunities, Business Challenges and Solutions, Overview of Strategic Business Case, Key Focus Areas for the Future, and Overview of Strategic Goals and Metrics. The Business Status section can include: Industry and Analysts View of the Business; Current Development Efforts; Current Service Efforts; Current Manufacturing Efforts; Current Customer Commitments; and Current State of the Business.

The Strategic Goals and Metrics section can include: Financial Goals and Metrics (which includes Sales Growth, Revenue Growth, Profit Growth, Asset Growth, Return on Sales, Return on Assets, and Return on Capital); Market Positioning Goals; and Corporate-Level Organizational Goals and Metrics (which includes Employee, Customer, Environmental, Schedule Integrity, Budget Integrity, and Goods and/or Services Quality). The section on Process-Centric Business Structure can include: Process-centric Overview; Core Process and Process Owners; Strategic Policies and Relationship to Core Processes; Mission Statements for Core Process Owners; and Infrastructure Requirements for Business Strategy Success. The Product and/or Services Overview can include: the Business Needs; the Solutions (Goods and/or Services); Solution Component Description (including Hardware Components; Software Components; Embedded Software Components; Independent Software Vendor Components; Third-Party Hardware Components; Service Components; Manufacturing Components; and Other Components); and Solution Information (including Origin of the Solution; Solution Uniqueness; How it Meets the Market Need; Markets Served; Patent Protection (if applicable); Historical Development (if applicable).

The Marketing Plan Section can include Market Research and Assumptions; Market Overview and Size (including Market Niche; History of the Market; Overview of the Current Market; Overview of the Current Competition; Overall Demand; and Total Sales and Growth Projection); Market Share and Segments (including Market Segments; Growth Projections; Market Niche; and Our Projected Market Share); Customer Profile (including Current; Projected; Market Data; and Market Analysis); Competition (including Market Status; Strengths; Weaknesses; and Financial Condition); Marketing Strategies (including Target Customers; Business Need; Customer Evaluation; Sales Strategies; and Service and Supply); Geographical Market Factors (including International Facility Development Impact on Sales; and ISO Qualification Marketing Considerations); Barriers to Market Entry; Sales Forecasts (including Current Year; Next Year; Five Year Plan; and Forecast); Sales Methods; Pricing and Value (including Pricing and Volume Sensitivity); Advertising and Promotions; and Trade Marks, Copyrights, Licensing, and Patents (including Trade Marks; Copyrights; Licenses; Patents; Strength and Terms of Protection; Conformance to Government, ISO, and IEEE Standards; and Litigation Issues).

The Overview of Organizational Business Plans can include sections on Software Engineering; Embedded Engineering; Hardware Engineering; Operations; Manufacturing; Customer Service and Delivery; Training and Education; Raw Materials and Supplies; Facility Plan; Administration Plan; Employment and Personnel Plans; Financial Plans; and Other Plans. The Technology Strategy section includes: Overview of Current Technology Infrastructure; Overview of Current Technology Plans; Overview of Planned Technology Infrastructure; Overview of Technology Opportunities; Infrastructure Requirements for Technology Strategy Success; and Overview of Future Technology Plans. The Overview of Technology Requirements and Plans section includes: Software Engineering; Embedded Engineering; Hardware Engineering; Operations; Manufacturing; Customer Service and Delivery; Training and Education; Facility Plan; Administration Plan; Employment and Personnel Plans; Financial Plans; and Other Plans.

The Financial Summary section can include: Summary Income Statement; Financial Model Description; Business Case 1 (Best-Case Scenario); Business-Case 2 (Mid-Range Scenario); and Business Case 3 (Worst-Case Scenario). The Cash Overview section includes: Overview of Cash Sources (including from Operations and Other Sources); and Overview of Cash Uses. Detailed information for this section can be contained in a detailed Cash Flow Statement.

The Issues, Assumptions, and Dependencies section can include: Assumptions; Dependencies (including Software, Hardware, Facilities, Telecommunications, Customer Support, Manufacturing, Services, Network, Sales, and Personnel); Issues; Alternatives/Contingency Plans (including Tracking and Status on High-risk Items, and Schedule and Resource Impacts); and Unproven Technologies.

The BMP Overview section can include: Introduction; Purpose; Scope; Customization; Resources; Software; Hardware; Training; Personnel; Organizational Roles and Responsibilities; and BMP Documentation. The BMP Transition Overview can be included for the transition from a traditional organization to a process-centric organization. The details of the transition work may be documented in a separate Project Plan. This section may be removed once all BMP conversion work is completed. This section can include: Introduction; Purpose; Scope; Transition Deliverables; Resources; and Transition Support Requirements.

In the foregoing, sections that can be included in the Business and Technology Strategic Plan were specified in great detail. It should be appreciated that the Business and Technology Strategic Plan can be tailored to meet an individual company's needs. Therefore, in alternate embodiments, the Business and Technology Strategic Plan may not include every section described above, or may include additional or different sections

### Market Analysis Phase

The Market Analysis Phase 110 is a phase in which the marketing, sales, service, and other organizations responsible for the development of products and services conduct research to ensure that the deliverables from the Executive Planning Phase 100 and proposed goods and/or services have a viable market, meet the needs of the target customer, and have the potential for success based on current and projected competition.

According to one embodiment of the invention, the Market Analysis Phase 110 involves identifying strategic trends for the company's customer set. Customer feedback and strategic trends may be mapped to the Business and Technology Strategic Plan 230. The Market Analysis Phase 110 may also involve evaluating the business' current competition and/or identifying and evaluating the future competition.

In this phase, the business may also define its customers' view of strategic requirements for their business problems. The current solution set and/or the future solution set offered by the business may be mapped to those requirements. Finally, product-specific or service-specific requirements may be a deliverable of this phase.

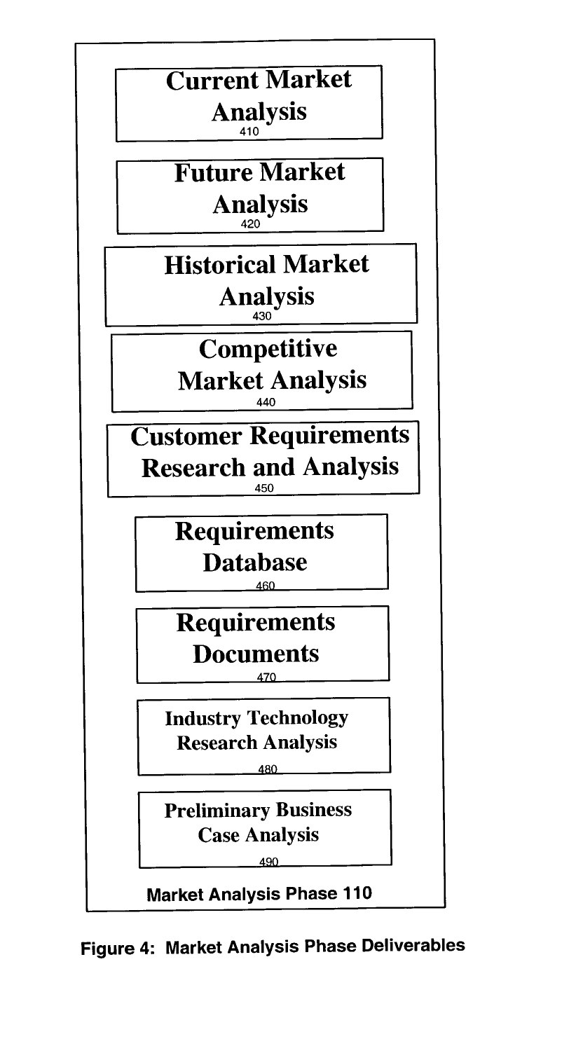

The deliverables of the Market Analysis Phase 110 according to one embodiment of the invention will now be described with reference to FIG. 4. These deliverables include a Current Market Analysis 410, a Future Market Analysis 420, a Historical Market Analysis 430, a Competitive Market Analysis 440, Customer Requirements Research and Analysis 450, a Requirements Database 460, Requirements Documents 470, an Industry Technology Research Analysis 480, and a Preliminary Business Case Analysis 490. In alternate embodiments, the Market Analysis Phase 110 may include additional or fewer deliverables.

The Current Market Analysis 410 may document the research of the company's currently identified target customer, market niche for proposed goods and/or services, estimated market share, estimated value of market, projections for time to attain estimated market share, estimated sales pricing, and estimated revenue and profit based on this research and the estimates. The Future Market Analysis 420 may have the same content as the Current Market Analysis 410, but is typically a long-term forecast. For example, the Future Market Analysis 420 may be focused on one, three, and/or five-year estimates based on anticipated growth, shrinkage, and other anticipated changes for the target market.

The Historical Market Analysis 430 is an analysis of the accuracy of historical estimates and forecasts that have been conducted by marketing, sales, engineering, manufacturing, service organizations, and/or market research firms used by the company. It is used to gauge the accuracy of current and future estimates. The Competitive Market Analysis 440 documents the identification of the current and future competition in the market and information pertaining to existing competitive products and anticipated future competitive products, including projections on when future products will enter the market. Customer Requirements Research and Analysis 450 contains research conducted with current, past, and/or potential customers to determine why they have chosen the company's goods and/or services, why they have selected particular suppliers and/or changed to other suppliers, why they selected competitive goods and/or services, and what they want in future goods and/or services. This research may serve as a basis for defining the strategic and tactical requirements for the company's goods and/or services.

The Requirements Database 460 is a database that may include the contact information from the Customer Requirements Research and Analysis 450 and the actual requirements for the company's current and proposed goods and/or services. The Industry Technology Research Analysis 480 may contain an analysis based on research of current and projected technology and its impact on the development of goods and/or services. It may also contain information on how the company will compare with the “state of the art” technology that currently exists. This information may also be projected for the future.

The deliverables of the Market Analysis Phase 110 may be directly linked to the company's business strategy and goals. The deliverables from the Executive Planning Phase 100 may be reviewed for accuracy and reworked based on the deliverables generated in this phase. For example, feedback from the Market Analysis Phase 100 may be used as the basis for reviewing the Business and Technology Strategic Plan 230 to ensure it is practical and the business environment supports it. The Strategic Goals and Metrics 220 and/or Business and Technology Strategic Plan 230 may be updated based on the Market Analysis Phase 110. After reviewing and finalizing the Strategic Goals and Metrics 220 and/or the strategies documented in the Business and Technology Strategic Plan 230, the marketing organization may develop a detailed Marketing Plan, which may be included in the Business and Technology Strategic Plan 230.

### Organizational Planning Phase

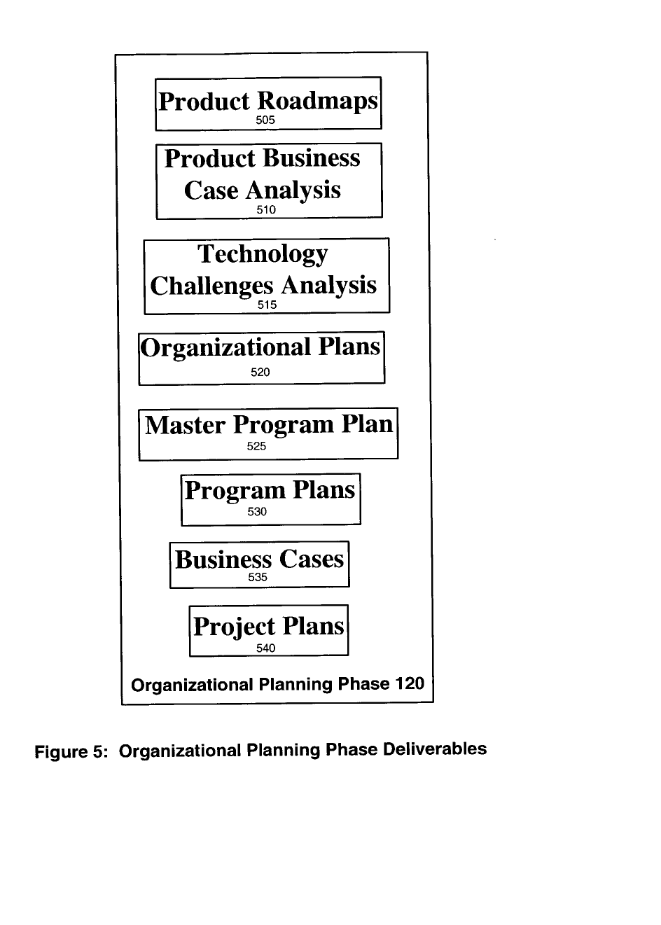

The Organizational Planning Phase 120 will now be described with reference to FIG. 5. The Organizational Planning Phase 120 is the phase where the owners and users of the Core Processes 260 of the company develop plans for producing goods and/or services and define their organizational goals in support of the Business and Technology Strategic Plan 230 and to attain the Strategic Goals 220 defined in the Executive Planning Phase 100. According to one embodiment of the invention, the deliverables of this phase include: Product Roadmaps 505, Product Business Case Analysis 510, Technology Challenges Analysis 515, Organizational Plans 520, Master Program Plan 525, Program Plans 530, Business Cases 535, and Project Plans 540. It is contemplated that in alternate embodiments there may be fewer or more deliverables in this phase.

In the Organizational Planning Phase 120, technology and/or business differentiators between the business and its competition may be identified. The Product Roadmaps 505 may include current products and/or services roadmaps as well as future products and/or services roadmaps. The current products/services roadmaps document the evolution of existing goods and/or services with major functional enhancements by release from inception to product/service end-of-life, or the various levels of service provided in a multi-tier approach for providing services with escalating financial changes as more services are provided to the customer. Future products/services roadmaps document the evolution of proposed goods and/or services in a similar fashion as that described in reference to current products/services roadmaps. Product Roadmaps 505 may be based on the Business Technology Strategic Plan 230 and the deliverables of the Market Analysis Phase 110.

Product Business Case Analysis 510 is a business case analysis of the company's products and/or services. The Technology Challenges Analysis 515 is an analysis of identified technology issues for current and future goods and/or services that is used in risk management, including risk assessment and risk mitigation.

Organizational Plans 520 are plans developed by the organizations responsible for work as part of the Core Processes 260. These plans document how the organization will execute their portion of the Business and Technology Strategic Plan 230. Further details on what sections may be included in an Organization Plan can be found later in this application.

The Master Program Plan 525 is the plan for all the goods and/or services programs that the company is developing during a predefined time frame. For instance, the predefined time frame can be quarterly, semi-annually, annually, or another timeframe that meets the particular needs of the company. The Master Program Plan 525 provides an overview of how the various programs are integrated, how the programs are linked to the Business and Technology Strategic Plan 230 and the Strategic Goals 220, and identifies the organizations and resources responsible for successful deployment of each separate goods/services program. Program Plans 530 are the plans for each specific goods/services program that is currently staffed and budgeted within the company. The Program Plans 530 describe the cross-functional team, their responsibilities, and references the individual department/project plans.

Product-specific Business Cases 535 and release-specific Project Plans 540 are also deliverables of this phase. The infrastructure required for success may be determined. Resource plans for the company's organizations may also be developed in this phase.

The deliverables of the Organizational Planning Phase 120 may be directly linked to the Business and Technology Strategic Plan 230 and the deliverables from the Market Analysis Phase 110 to ensure that the products, solutions, and/or services selected for development will meet the company's strategic direction and will meet customer business and technology requirements. A review of all of the previous phases' deliverables may also be conducted during this phase to ensure that data produced in the previous phases does not require changes based on the work produced during this phase. The series of plans that constitute the deliverables of this phase may form the core of quarterly business decisions and future resource allocation.

### Organization Plan

The Organization Plan is one of the deliverables from the Organization Planning Phase. It can include a General Information section; an Assumptions, Dependencies, and Issues section; a Resource Allocation Request section; and an Implementation Plan section.

The General Information section can include: Plan Overview; Purpose; Scope; References; Definitions, Acronyms, and Abbreviations; Organizational Plan Keywords; Organizational Plan Requirements; Organization Chart; Overview of Organizational Responsibility; Overview of Organizational Core Process; Organization Goals and Metrics (including Program Goals and Metrics; and Project Goals and Metrics); Deliverables Overview; Schedule Estimate Overview; Resources (including Software, Hardware, and Personnel); Support Requirements (including System Administration); Research and Development Environment Considerations; Tools (Hardware, Manufacturing, Service, Software, Network, and Facilities); Training; and Configuration Management); Budget and Expenses (including Budget and Expenses Overview); Capital Funding; and Expense Funding (including Consulting Work; expenses for Internal Training; and Expenses for External Training); Plan Approval Process; and Other Processes (including Business Evaluation and Planning Process; BMP Model Customization Process; Document Management Process; and Configuration Management Process).

The Assumptions, Dependencies, and Issues section can include: Assumptions; Dependencies (including Software, Hardware, Facilities, Telecommunications, Customer Support, Manufacturing, Services, Network, System time, Personnel, and Budget); Issues; Alternative/Contingency Plans (including Tracking and Status on High-risk Items; and Schedule and Resource Impacts); and Unproven Technologies. The Resource Allocation Request can include: Overview of Business Cases; Risk Assessment; Budget; Headcount; Other Resources; ROI; and Schedule.

The Implementation Plan section can include: Assumptions from Resource Allocation Request; Schedule Estimates; Schedule Integrity Goal and Metrics; Program Team Description and Responsibilities; Project Team Descriptions and Responsibilities; Tracking Metrics and Analysis; Status Reporting; Risk Contingency Planning and Mitigation; Program Specific Information; and Project Specific Information.

In the foregoing, sections that can be included in the Organization Plan were specified in great detail. It should be appreciated that the Organization Plan can be tailored to meet an individual company's needs. Therefore, in alternate embodiments, the Organization Plan may not include every section described above, or may include additional or different sections.

### Resource Allocation Phase

In the Resource Allocation Phase 130, the executive and organizational managers assign corporate resources based on the deliverables from one or more of the previous phases to attain the Strategic Goals 220 and to execute the Business and Technology Strategic Plan 230. This phase may involve evaluating Resource Plan requests by research and development requirements, infrastructure requirements, and development project requirements. Previous phase outputs, and new and current business opportunities may be evaluated in this phase. In this phase, allocations may be made to Research & Development, infrastructure, development projects, and service organizations and the work for these categories may be prioritized. Additionally, projected revenue and profit for projects may be estimated and project resources and budget may be allocated based on the Return on Investment.

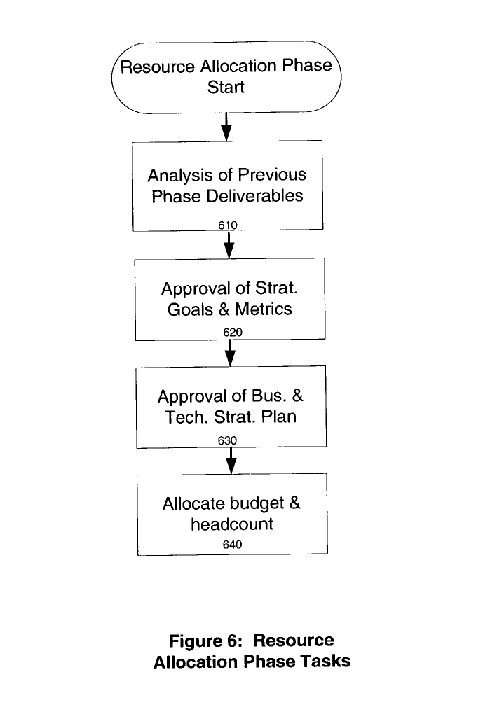

FIG. 6 illustrates the tasks that may be performed in the Resource Allocation Phase 130 according to one embodiment of the invention. In task 610, an analysis of the deliverables of the previous phase is conducted. This analysis may produce a ranking of programs and organizations for allocation of resources for the timeframe defined by the company. This time-frame may be quarterly, semi-annually, annually, or another time-frame that meets the company's needs. The analysis may also include an estimated amount of resources required for successful completion of the program and obtaining approval by management for initial or ongoing funding of projects based on the deliverables from the previous phases and this analysis.

In task 620, the revised Strategic Goals & Metrics 220 is approved. In task 630, the revised Business & Technology Strategic Plan 230 is approved. Task 640 allocates budget and headcount based on the revised Business & Technology Strategic Plan 230, market research, Business Cases 535, Product Roadmaps 505, Organization Plans 520, Program Plans 530, and Project Plans 540. In alternate embodiments, the tasks described above in reference to FIG. 6 may be performed in a different order. For example, approval of the Business & Technology Strategic Plan 230 may be performed before approval of the Strategic Goals & Metrics 220. Additionally, alternate embodiments may include additional or fewer tasks than those described.

The deliverables of the Resource Allocation Phase 130 may be directly linked to the strategy defined in the Business and Technology Strategic Plan 230 and to the results of the Market Analysis Phase 110 to ensure that the products, solutions and/or services developed will meet the customer's business and technology requirements. This linkage may also help ensure that the priorities of the Product Roadmaps 505 and Organizational Plans 540 are supported with funding, staffing, and company infrastructure.

### Implementation Phase

The Implementation Phase 140 is a phase in which the responsible organizations and owners of the Core Processes 260 execute the Business and Technology Strategic Plan 230 and their Organizational Plans 320 using the allocated budget and resources from the previous phase. This phase may involve implementing Project Plans 350 for development. Infrastructure upgrades, such as hardware and software upgrades, may also be implemented. Required staff may be hired in this phase and staff training and education may also be provided.

Additionally, a Research & Development analysis of previously identified projects may be conducted. Research & Development prototyping and modeling may also occur in this phase. An additional business analysis and a market analysis based on the Research & Development work may be conducted. Finally, potential new Research & Development opportunities may be identified and Research & Development may be evaluated for product development.

The deliverables of the Implementation Phase 140 may be directly linked to the outputs of the previous phases. The deliverables may ensure that programs and projects selected for Resource Allocation are successfully implemented “on time” and “on budget” with an acceptable level of quality to meet customer's business and technology requirements.

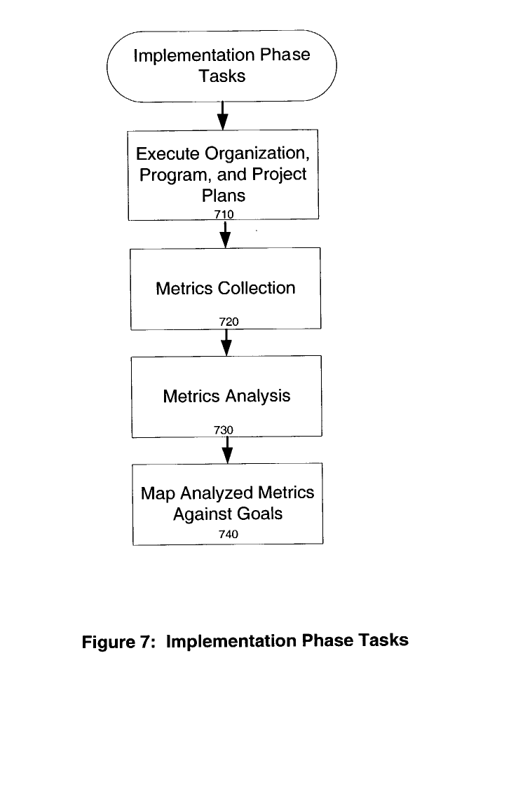

FIG. 7 illustrates tasks that may be performed in the Implementation Phase 140 according to one embodiment of the invention. Task 710 involves the execution of all Organization Plans 520, Program Plans 530, and Project Plans 540 scheduled to be performed in the time-frame designated by the company. This time-frame may be quarterly, semi-annually, annually, or some other time-frame that meets the needs of the company. In task 720, metrics are collected on data required for executive-defined Strategic Goals & Metrics 220 and the organization-defined metrics required to measure goal achievement and progress, as well as other critical data points defined by the company or by program/project teams. Task 730 involves the analysis of the metrics collected in task 720. Finally, in task 740, the analyzed metrics are mapped against department and corporate goals.

In alternate embodiments, fewer tasks or additional tasks than those described above may be performed.

### Evaluation Phase

In the Evaluation Phase 150, estimated data that was collected throughout the BMP Lifecycle is mapped to the actual execution data specifically collected during the Implementation Phase 140 to provide management with metrics for decision making and to improve business performance. The deliverables of the Evaluation Phase 150 may be ongoing and continue throughout the lifecycle of development and distribution for which resources have been allocated in the previous phase. This allows the early termination of development efforts that have unresolved technology issues, or budget and schedule integrity problems before capital investments become draining to the company. This also allows evaluation of development teams to ensure that they are staying on budget and schedule. Moreover, the metrics help management identify and remedy potential problems before they become critical to the success of the company.

In the Evaluation Phase 150, estimates versus actuals for operational revenue, operational profit, development and deployment budget integrity, and development and deployment schedule integrity may be compared. Contractual and partnership obligations may be evaluated. Customer feedback on satisfaction and quality may also be obtained in this phase. This phase may also involve examining the impact on company Vision 210, Strategic Goals & Metrics 220, and Business and Technology Strategic Plan 230. All implementation phase work may be ranked by category.

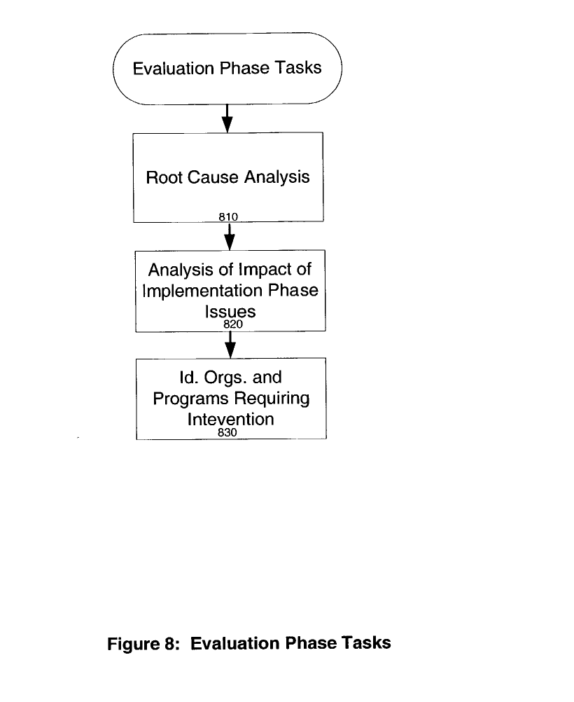

FIG. 8 illustrates tasks that may be performed in the Evaluation Phase 150 according to one embodiment of the invention. In task 810, root cause analysis for failure and successes may be conducted. The root cause analysis is an analysis of “what happened” for specific issues, successes, and problems on a program or project-level basis to determine “why it happened” to prevent future problems and to expand on past successes. The issues analyzed may include rework, product deficiencies, requirements churn, schedule integrity, budget integrity, goal attainment integrity, risk analysis and mitigation, and plan execution. Lessons learned may be documented and distributed to prevent failures and to ensure future successes.

In task 820, an analysis of Implementation Phase 140 issues is conducted to determine the impact on future plans. In task 830, a list of organizations and programs requiring management intervention is identified.

In alternate embodiments, the tasks described in reference to FIG. 8 may be performed in a different order. Some tasks may be omitted and/or additional tasks may be added to meet the particular needs of a company.

### Modification Phase

In the Modification Phase 160, the results of the Evaluation Phase 150 are used to adjust future plans, identify existing and potential problems, and to define areas where improvement is needed throughout the business. All phase outputs may be reviewed by executives and selected high-level managers in the Modification Phase 160 to determine what elements of the company or programs need improvement. Linkages between the phases may be reviewed to determine if they have been successful. In this phase, linkage and outputs that require repair may be identified. Additionally, development projects, Research & Development projects, and infrastructure projects may be identified for new opportunities, and for cancellation. Manufacturing and services are also reviewed for increased productivity and quality enhancement.

The entire cycle may also be reviewed for changes based on Return on Investment. New opportunities may be reviewed and selected for “strategic fit.” This phase may also involve updating previous phase outputs; communicating changes to the organization; and rewarding successes and lessons learned.

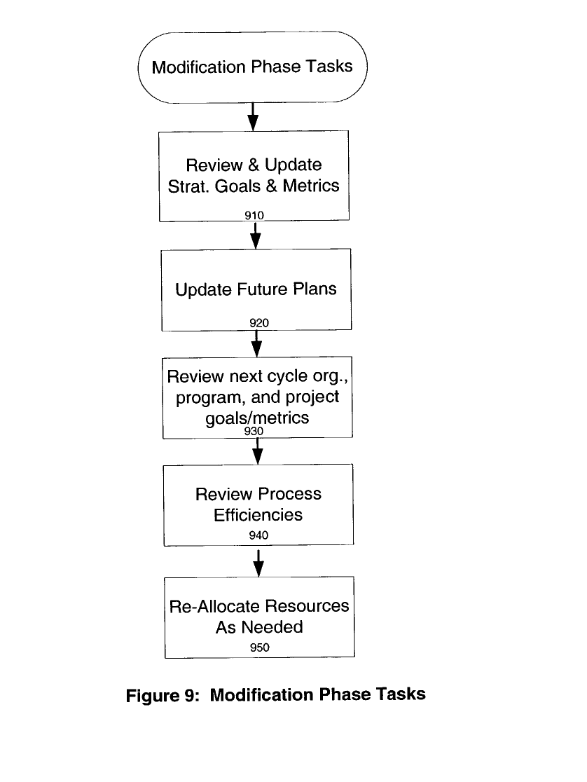

FIG. 9 illustrates tasks that may be performed in the Modification Phase 160 according to one embodiment of the invention. In alternate embodiments, some of these tasks may be omitted or additional tasks may be performed. In addition, these tasks may be performed in a different order.

In task 910, the Strategic Goals and Metrics 220 are reviewed and updated as needed. Task 920 involves the updating of future plans based on metrics analysis. A review of the next cycle's organization, program, and project goals and metrics based on the previous cycle's results is conducted in step 930. In task 940, process efficiencies are reviewed and updated as needed. Finally, in task 950 resources are re-allocated as needed based on metrics analysis.

The deliverables of this phase may be ongoing and continue throughout the life of the business. This phase allows for complete strategic, operational, implementation, and evaluation reviews that allow business decisions to be made based on analyzed data, rather than by the “seat of the pants” as many business decisions are currently made. This phase also allows for the continuous review of the company's strategic direction and may provide the ability to quickly respond to changes in the business environment before they have a negative impact on the company. In one embodiment, this phase is performed on a quarterly basis. In alternate embodiments, this phase may be performed on a monthly, semi-annually, annually, or other time-frame that meets a particular business' needs.

### Alternative Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

What is claimed is:

1. A method for managing a business comprising:
developing a framework for a business management process for the business;
identifying a business and technology strategic plan;
identifying strategic trends for the business;
developing one or more plans for producing one or more of goods and services;
defining strategic goals;
allocating corporate resources to execute the business and technology strategic plan; and
executing the business and technology strategic plan.

2. The method of claim 1, further comprising identifying strategic goals and metrics.

3. The method of claim 3, wherein the strategic goals and metrics comprise corporate goals, one or more questions for evaluation of work towards those goals, and a list of metrics collected for answering the questions.

4. The method of claim 4, further comprising periodically adjusting one or more of: the business and technology strategic plan, the strategic trends, the one or more plans, and the strategic goals.

5. The method of claim 5, further comprising identifying customer requirements.

6. The method of claim 6, further comprising developing a vision statement.

7. A method for managing a business comprising:
conducting an executive planning phase;
producing one or more deliverables during the executive planning phase;
conducting a market analysis phase;
producing one or more deliverables during the market analysis phase;
conducting an organizational planning phase;
producing one or more deliverables during the organizational planning phase;
conducting a resource allocation phase;
conducting an implementation phase; and
conducting an evaluation phase.

8. The method of claim 7, further comprising conducting a modification phase.

9. The method of claim 7, wherein the one or more deliverables of the executive planning phase comprise one or more of: a vision statement, strategic goals, metrics, strategic policies, core processes, infrastructure, and missions.

10. The method of claim 7, wherein the one or more deliverables of the market analysis phase comprise one or more of: a current market analysis, a future market analysis, a historical market analysis, a competitive market analysis, customer requirements research and analysis, a requirements database, one or more requirements documents, a industry technology research analysis, and a preliminary business case analysis.

11. The method of claim 7, wherein the one or more deliverables of the organizational planning phase comprise one or more of: a product roadmap; a product business case analysis; a technology challenges analysis; an organizational plan; a master program plan, a program plan, business cases, and a project plan.

12. The method of claim 7, wherein conducting a resource allocation phase comprises allocating a budget and one or more people to execute a business and technology strategic plan.

13. The method of claim 7, wherein conducting an implementation phase comprises executing one or more organization, program and project plans.

14. The method of claim 7, wherein conducting an evaluation phase comprises analysis of one or more metrics collected during the implementation phase.

15. A method for managing a business comprising the steps of:
a step for conducting an executive planning phase;
a step for producing one or more deliverables in the executive planning phase;
a step for conducting a market analysis phase;
a step for producing one or more deliverables in the market analysis phase;
a step for conducting an organizational planning phase;
a step for producing one or more deliverables in the organizational planning phase;
a step for conducting a resource allocation phase;
a step for conducting an implementation phase; and
a step for conducting an evaluation phase.

16. The method of claim 15, further comprising a step for conducting a modification phase.

17. The method of claim 16, wherein the one or more deliverables of the executive planning phase comprise one or more of: a vision statement, strategic goals, metrics, strategic policies, core processes, infrastructure, and missions.
